(19) United States
(12) Patent Application Publication
(10) Pub. No.: US 2024/0020269 A1
(43) Pub. Date: Jan. 18, 2024

(54) METHOD, ELECTRONIC DEVICE, AND COMPUTER PROGRAM PRODUCT FOR SEARCHING FOR DATA

(71) Applicant: Dell Products L.P., Round Rock, TX (US)

(72) Inventors: Zhenzhen Lin, Shanghai (CN); Si Chen, Shanghai (CN); Anzhou Hou, Shanghai (CN)

(21) Appl. No.: 17/880,796

(22) Filed: Aug. 4, 2022

(30) Foreign Application Priority Data
Jul. 15, 2022 (CN) 202210837573.4

(51) Int. Cl. G06F 16/13; G06F 16/182

(52) U.S. Cl. CPC G06F 16/137; G06F 16/182

(57) ABSTRACT

Embodiments of the present disclosure include a method, an electronic device, and a computer program product for searching for data. The method includes: determining, in response to receiving at a requesting node a search request for target data, a data identifier of the target data; and determining whether the data identifier of the target data is a local data identifier or a global data identifier. The method further includes: searching for the target data using a local distributed hash table in response to determining that the data identifier is the local data identifier; and searching for the target data using a global distributed hash table in response to determining that the data identifier is the global data identifier. By using this method, it is possible to enable quick lookup of various types of data among nodes in a distributed system in a low-latency, flexible, and efficient manner.

### RELATED APPLICATION(S)

The present application claims priority to Chinese Patent Application No. 202210837573.4, filed Jul. 15, 2022, and entitled “Method, Electronic Device, and Computer Program Product for Searching for Data,” which is incorporated by reference herein in its entirety.

### FIELD

Embodiments of the present disclosure relate to the field of data processing and, more specifically, to a method, an electronic device, and a computer program product for searching for data in a distributed system.

### BACKGROUND

Nodes in an edge architecture are typically massively and widely distributed dynamically and have network instability. Distributed systems applying decentralization techniques can solve this problem while providing low-latency and efficient data services to users.

Distributed hash tables, also referred to herein as DHTs, are applied in a distributed system as the “infrastructure” of the distributed system to store a large amount of data in the distributed system, such as the identifiers of nodes in the distributed system, metadata, the distances between the nodes, and the like. Nodes in a distributed system can search for target data based on a distributed hash table.

### SUMMARY

Embodiments of the present disclosure provide a method, an electronic device, and a computer program product for searching for data in a distributed system.

According to a first aspect of the present disclosure, a method for searching for data is provided. The method includes: determining, in response to receiving at a requesting node a search request for target data, a data identifier of the target data. The method includes: determining whether the data identifier of the target data is a local data identifier or a global data identifier. The method further includes: searching for the target data using a local distributed hash table in response to determining that the data identifier is the local data identifier; and searching for the target data using a global distributed hash table in response to determining that the data identifier is the global data identifier.

According to a second aspect of the present disclosure, an electronic device is provided. The electronic device includes at least one processor; and a memory coupled to the at least one processor and having instructions stored therein, wherein the instructions, when executed by the at least one processor, cause the electronic device to perform actions comprising: determining, in response to receiving at a requesting node a search request for target data, a data identifier of the target data; determining whether the data identifier of the target data is a local data identifier or a global data identifier; searching for the target data using a local distributed hash table in response to determining that the data identifier is the local data identifier; and searching for the target data using a global distributed hash table in response to determining that the data identifier is the global data identifier.

According to a third aspect of the present disclosure, a computer program product is provided. The computer program product is tangibly stored on a non-transitory computer-readable medium and includes machine-executable instructions, and the machine-executable instructions, when executed by a machine, cause the machine to execute steps of the method in the first aspect of the present disclosure.

### BRIEF DESCRIPTION OF THE DRAWINGS

By description of example embodiments of the present disclosure, provided herein in more detail with reference to the accompanying drawings, the above and other objectives, features, and advantages of the present disclosure will become more apparent. In the example embodiments of the present disclosure, the same reference numerals generally represent the same elements.

FIG. 1 illustrates a schematic diagram of an example environment in which a device and/or a method according to an embodiment of the present disclosure can be implemented;

FIG. 2 illustrates a flow chart of a method for searching for data according to an embodiment of the present disclosure;

FIG. 3 illustrates a schematic diagram of a dual-distributed hash table at a node according to an embodiment of the present disclosure;

FIG. 4 illustrates a flow chart of another embodiment in which searching is performed using both a local distributed hash table and a global distributed hash table according to an embodiment of the present disclosure;

FIG. 5 illustrates a schematic diagram of another embodiment in which searching is performed using both a local distributed hash table and a global distributed hash table according to an embodiment of the present disclosure;

FIG. 6 illustrates a schematic diagram of management of geographic information identifiers within a node; and

FIG. 7 illustrates a schematic block diagram of an example device applicable to implement embodiments of the present disclosure.

### DETAILED DESCRIPTION

Embodiments of the present disclosure will be described in more detail below with reference to the accompanying drawings. Although the drawings show some embodiments of the present disclosure, it should be understood that the present disclosure can be implemented in various forms, and should not be explained as being limited to the embodiments stated herein. Instead, these embodiments are provided for understanding the present disclosure more thoroughly and completely. It should be understood that the accompanying drawings and embodiments of the present disclosure are for illustrative purposes only, and are not intended to limit the protection scope of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

As described above, due to the mobility of a node itself, when the node searches for or acquires, according to a distributed hash table, data outside a region where the node is located or data that does not belong to any region, the node may traverse a longer search path or go through more hops to find target data or metadata associated with the target data in order to locate the target data. Performing cross-region lookups may typically take a long time, which leads to degraded performance in searching and acquiring data in a distributed system. Moreover, the geographic information identifier for particular data may change. For example, a vehicle or cell phone with target data stored may serve as a target data node, and when the vehicle or cell phone leaves one region and enters another region, the geographic information identifier of the target data may change as the geographic location of the target data node changes. In this case, if the requesting data node continues to search for the target data using the unchanged geographic information identifier, the search may fail due to the change of the geographic information identifier.

In addition, some data per se are used in the distributed system as global data of the distributed system, in which case it may take a longer time for the requesting node to search for the target data based on the geographic information identifier in the local data identifier compared to searching the global data directly, thus resulting in a longer latency. For example, in a system in which a city is a distributed system, the electricity price for the city is uniform and globally used, and the electricity price is not uniquely owned by any one residential complex or institution. In this case, if a requesting node (e.g., a cell phone) intends to search for the adjusted electricity price, the requesting node may look it up directly in the distributed system based on the attributes of the target data itself, such as the global identifier of the target data, thus reducing the time required for the search in this way.

At least to address the above and other potential problems, an embodiment of the present disclosure provides a method for searching for data. The method includes: determining, in response to receiving at a requesting node a search request for target data, a data identifier of the target data. The method includes: determining whether the data identifier of the target data is a local data identifier or a global data identifier. The method further includes: searching for the target data using a local distributed hash table in response to determining that the data identifier is the local data identifier; and searching for the target data using a global distributed hash table in response to determining that the data identifier is the global data identifier. By using the method as described in embodiments of the present disclosure, it is possible to enable lookup of various types of data among nodes in a distributed system based on the proximity of the nodes to each other, the attributes of the data itself, and other factors in a low-latency, flexible, and efficient manner.

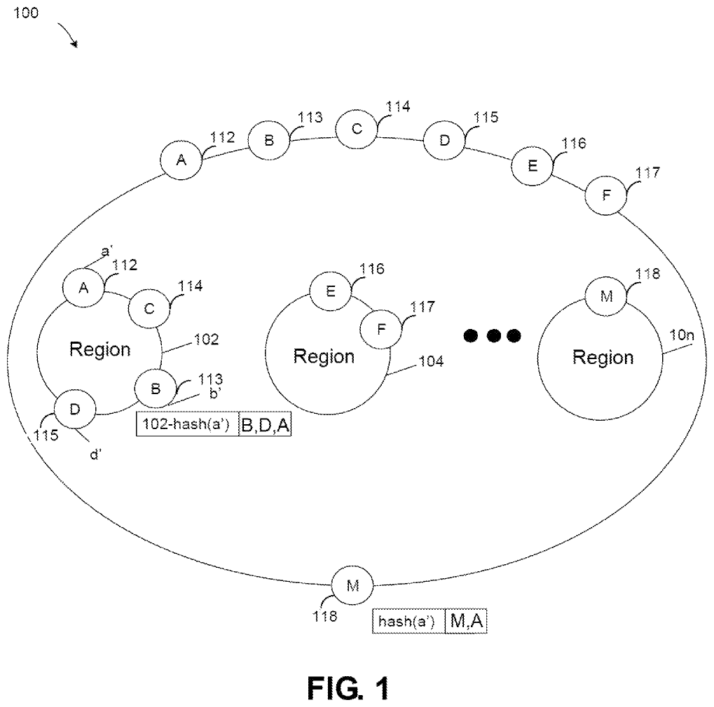

The fundamental principles and several example embodiments of the present disclosure will be described in detail below with reference to the accompanying drawings. Among them, FIG. 1 illustrates a schematic diagram of distributed system 100 in which the device and/or method of embodiments of the present disclosure may be implemented. It should be understood that the number and arrangement of nodes, elements, and regions illustrated in FIG. 1 are examples only, and different numbers and different arrangements of nodes, elements, and regions may be included in distributed system 100.

FIG. 1 illustrates distributed system 100 including node A 112 to node M 118 and region 102 to region 10n.

The nodes may be any devices with processing computing resources or storage resources. For example, the nodes may have common capabilities of receiving and sending data requests, real-time data analysis, local data storage, real-time network connectivity, and the like. The nodes can typically include various types of terminal devices. Examples of the terminal devices include, but are not limited to: desktop computers, laptop computers, smart phones, wearable devices, security devices, smart manufacturing devices, smart home devices, Internet of Things (IoT) devices, smart cars, drones, and the like. It should be understood that although only node A 112 to node M 118 are shown in FIG. 1, this is merely an example and not a specific limitation of the present disclosure. Any number and any type of nodes may be included in distributed system 100.

Distributed system 100 may be divided into various regions based on relevant factors such as proximity of geographic locations. As an example, distributed system 100 in FIG. 1 illustrates n regions: region 102 to region 10n, wherein a region may refer to a region that is obtained through division based on the geographic location, the logical location, and other factors, such as a residential complex, a block, a city, and so on. Depending on whether a node falls within an actual physical distance range of a region or a logical distance range of the region, the region may contain zero or more nodes. As shown in FIG. 1, since node A 112, node B 113, node C 114, and node D 115 all fall within the actual physical distance range of region 102, node E 116 and node F 117 both fall within the actual physical distance range of region 104, and node M 118 falls within the actual physical distance range of region 10n, region 102 may contain node A 112, node B 113, node C 114, and node D 115, while region 104 may contain node E 116 and node F 117, and region 10n may contain node M 118. It should be understood that although only region 102 to region 10n and node A 112 to node M 118 are shown in FIG. 1, this is merely an example and not a specific limitation of the present disclosure. In distributed system 100, any number of regions that are divided according to any criteria may be included. Likewise, it should be understood that the above division criteria for a node falling within a region is only an example, and the criteria may be determined based on any factor, which is not limited in the present disclosure.

Each node in distributed system 100 may store data and/or metadata for that data. For example, one node stores data, and another node stores metadata corresponding to the data. The metadata is used to describe the attributes of the data, and the metadata may include a data identifier that includes a hash identifier obtained by hashing the data by a hash algorithm. Further, a data generator may categorize the data identifier as a local data identifier or a global data identifier based on the corresponding attributes of the data. For example, when generating data, depending on whether the data will be used within a region or will be used across distributed system 100, the data generator may categorize the data identifier as a local data identifier or a global data identifier, where the local data identifier may have a geographic information identifier characterizing the region in which the node storing the data is located. An illustration is given with a node in region 102 as an example. Node A 112 in this region 102 has data a′, whereas node B 113 stores metadata associated with data a′, wherein the metadata may include a data identifier corresponding to data a′ and routing information for data a′. If it is determined that data a′ will be used within region 102, data a′ may be hashed to obtain the hash identifier hash(a′), and geographic information identifier “102-” characterizing the region in which the node storing this data is located will be added by the data generator, that is, the data identifier may be represented as a local data identifier 102-hash(a′). Further, for example, in response to the fact that data a′ may also be used across the entire distributed system 100, the data identifier associated with data a′ may include only the hash identifier obtained by hashing data a′, i.e., the global identifier hash(a′), which may then be stored at node M 118, wherein node M 118 may be the node that is closest to node A 112 with respect to the entire distributed system 100. It should be understood that although the data identifier is categorized as a local data identifier or a global data identifier based on the criteria of whether the data will be used within a certain region or will be used across distributed system 100 in the above examples, this is merely an example and not a specific limitation to the present disclosure. In the present disclosure, all data identifiers may be categorized into any types of data identifiers according to any criteria, which is not limited in the present disclosure. Routing information may include routing information of data a′. In addition, the metadata may also include the size of the data, the source of the data, and the like, which are not limited in the present disclosure.

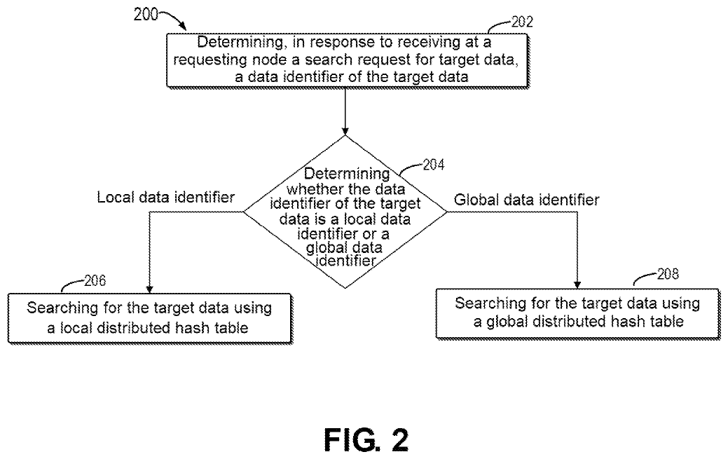

Example distributed system 100 according to some embodiments of the present disclosure has been described above in conjunction with FIG. 1. A flow chart of method 200 for data storage according to some embodiments of the present disclosure will be described below with reference to FIG. 2. Method 200 may be implemented by distributed system 100 of FIG. 1. It should be understood that method 200 can also be performed by other appropriate devices or apparatuses. Method 200 may include additional actions not shown and/or may omit actions shown, and the scope of the present disclosure is not limited in this regard. For ease of description, method 200 will be described with reference to FIG. 1.

As shown in FIG. 2, at block 202, upon receiving a search request for target data, a requesting node in distributed system 100 determines a data identifier of the target data. As described above, the node may be a terminal device having capabilities of receiving and sending data requests, real-time data analysis, local data storage, real-time network connectivity, and the like, so that the requesting node is capable of determining the data identifier for the target data from the received search request.

At block 204, the requesting node in distributed system 100 determines whether the data identifier of the target data is a local data identifier or a global data identifier. As described above, the data identifier of the target data may be categorized as a local data identifier or a global data identifier depending on whether the data will be used within a region or will be used across the distributed system, where the local data identifier may have a geographic information identifier characterizing the region in which the node storing the data is located. By determining whether the data identifier of the target data contains a geographic information identifier, the requesting node can determine whether the data identifier of the target data is a local data identifier or a global data identifier. For example, as shown in FIG. 1, target data a′ is stored in node A 112, a search request for target data a′ from other nodes in the same region may be received at node C 114, which is in the same region as node A 112. Since it is a search request from the same region, the data identifier of the target data in this request may be a local data identifier, i.e., 102-hash(a′), where “102-” is a geographic information identifier indicating that this target data is in region 102, and hash(a′) denotes a hash identifier obtained by hashing data a′. Meanwhile, node C 114 may also receive a search request for the target data a′ from other nodes that are outside of region 102 in distributed system 100, where the data identifier of the target data in the request may be the global data identifier hash(a′).

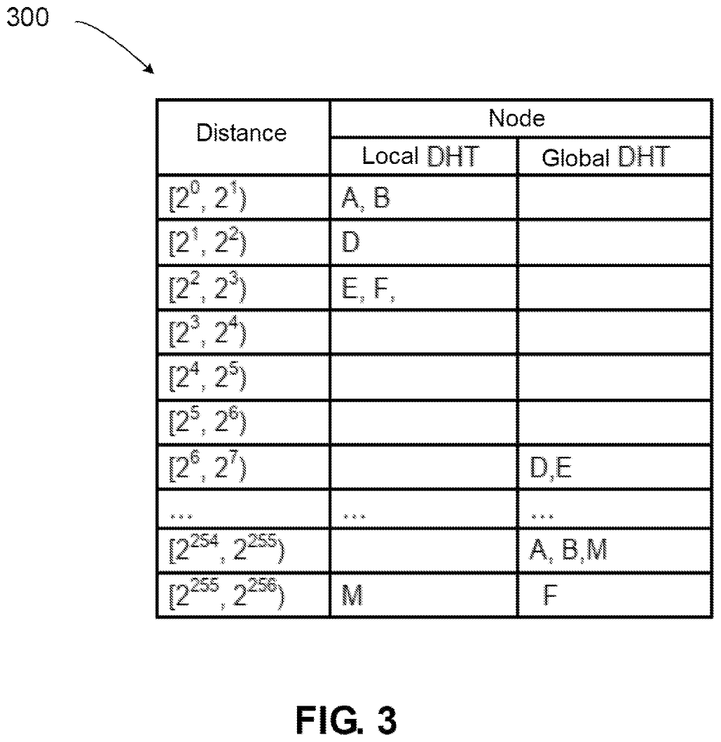

At block 206, in response to determining that the data identifier is the local data identifier, the requesting node in distributed system 100 may search for the target data using a local distributed hash table. In the present disclosure, a dual-distributed hash table (dual-DHT) may be stored at each node, wherein the dual-DHT is formed based on the distances from that node to other nodes, and the dual-DHT may include both a local distributed hash table and a global distributed hash table. The present disclosure will specifically describe the process of constructing a dual-DHT with reference to FIG. 3 below.

At block 208, in response to determining that the data identifier is the global data identifier, the requesting node in distributed system 100 may search for the target data using a global distributed hash table.

In some embodiments, upon receiving a data storage request, a node in distributed system 100 stores the data at the node. For example, upon receiving the data storage request, node A 112 may store the target data a′ at node A 112, and node B 113 may store the target data b′ at node B 113.

In some embodiments, a first node in distributed system 100 may store, based on the local distributed hash table, metadata for the data at a second node that is in the same region as the first node. Additionally or alternatively, the second node may be the node in the same region that is closest to the first node, and the distance between the first node and the second node may be obtained by calculating an exclusive OR distance. The metadata may include a data identifier and routing information, wherein the data identifier includes a hash identifier obtained by hashing the data using a hash algorithm, and the routing information may be recorded to routing data for the data. Data identifiers stored in nodes located in the same region may have the same geographic information identifiers characterizing the region in which the nodes are located. For example, node A 112, node B 113, node C 114, and node D 115 in distributed system 100 are all located in region 102, so they may all have the geographic information identifier “102-,” and node E 116 and node F 117 in distributed system 100 are in region 104, so they may both have the geographic information identifier “104-.” As an example, metadata associated with data a′ is also stored at node B 113, wherein the metadata may include a local data identifier 102-hash(a′) and routing information for the route from node B 113 to node A 112 where data a′ is stored.

In some embodiments, the first node in distributed system 100 may store, based on the global distributed hash table, the metadata for the data in a third node in the distributed system. Additionally or alternatively, the third node may be the closest node in distributed system 100 with respect to the first node. However, since the algorithm used to find the third node based on the global distributed hash table may be different from the algorithm used to find the second node based on the local distributed hash table, the closest nodes determined using the two algorithms may be different. Additionally or alternatively, the data identifiers in the nodes stored according to the global distributed hash table may not have geographic information identifiers. For example, since node M 118 in FIG. 1 is the closest node in distributed system 100 with respect to node A 112, metadata associated with data a′ in node A 112 may be stored in node M 118; and since the metadata stored in node M 118 is stored based on the global distributed hash table, the data identifier in the metadata at node M 118 may be denoted as “hash(a′)” without having a geographic information identifier.

Additionally or alternatively, the process in which the node stores metadata at the second node that is located in the same region based on the local distributed hash table may be performed in parallel with the process in which the node stores the metadata at the third node based on the global distributed hash table. For example, node A 112 in FIG. 1 may store the metadata associated with data a′ in both node B 113 and node M 118.

In some embodiments, searching, by the requesting node, the target data using both the local distributed hash table and the global distributed hash table includes: stopping, in response to the target data being found using the local distributed hash table, searching for the target data using the global distributed hash table; and stopping, in response to the target data being found using the global distributed hash table, searching for the target data using the local distributed hash table. For example, node C 114 may search for the target data a′ based on both the local distributed hash table and the global distributed hash table stored at that node C 114, and once it finds the target data a′ via one of the local distributed hash table and the global distributed hash table, it stops the lookup in the other hash table.

In some embodiments, searching, by the requesting node, the target data using the local distributed hash table may include: sending a search request for the target data to a plurality of nodes that are within a first distance range based on the local distributed hash table; and sending, in response to the target data being not found from the plurality of nodes that are within the first distance range, a search request for the target data to a plurality of nodes that are within a second distance range, wherein distances in the second distance range are greater than distances in the first distance range. For example, node C 114 may first send the search request for target data d′ to node A 112 and node B 113 that are within the first distance range, where the first distance range may be any value less than the size of the range of region 102 in this example. If the target data d′ or metadata associated with the target data d′ is not found at node A 112 and node B 113, node C 114 further sends a search request for the target data d′ to node D 115 that is located within the second distance range, where in this example the second distance range may be any value greater than the size of the first distance range and less than the size of the range of region 102. It should be understood that the distance range may be a range of any value from the requesting node, which is not limited in the present disclosure. Additionally or alternatively, the metadata for the target data may be stored in a plurality of nodes, and in response to the metadata for the target data being found at one of the plurality of nodes, requesting node C 114 may find the node storing the target data d′ based on routing information associated with the metadata, thereby finding the target data d′.

The process of establishing, at a node, dual-DHT 300 associated with the node will be described below in conjunction with FIGS. 1 and 3.

Hereinafter, an illustration is provided using node C 114 in distributed system 100 as an example. Node C 114 may first traverse all nodes in region 102 and record the nodes in region 102 into its local distributed hash table as a first part of its local distributed hash table according to the distance of the nodes from node C 114. For example, in FIG. 3, since node A 112 and node B 113 have the same distance range from node C 114, node A 112 and node B 113 are recorded in the distance range [2⁰, 2¹) of the local distributed hash table for node C 114; and since node D 115 is farther away from node C 114, node D 115 is recorded in the distance range [2¹, 2²) of the local distributed hash table for node C 114. It should be understood that a distance between nodes may be a logical distance obtained using an exclusive OR operation. Additionally or alternatively, the distance between nodes may also be an actual physical distance between the nodes, which is not limited in the present disclosure. Additionally or alternatively, the distance range of the first part of the local distributed hash table may be the size of region 102.

In the manner described above, node C 114 then traverses node E 116 and node F 117 in region 104 and records them in the local distributed hash table for node C 114 as a second part of its local distributed hash table. Additionally or alternatively, the distance range of the second part of the local distributed hash table may be the size of region 104.

By analogy, node C 114 may record each node in distributed system 100 in its local distributed hash table up to the last node, such as node M 118 in region 10n.

The process of establishing a global distributed hash table at a node may include generating the global distributed hash table based on distances between the requesting node and all nodes within a distributed system. For example, by performing a hash operation on each node based on the identifier space (which may be a size of 2²⁵⁶) of the entire distributed system, a longer node identifier can be obtained than that recorded in the local distributed hash table. Since the node identifier obtained in this manner is calculated with respect to the entire distributed system 100, the nodes are logically distant from each other, and thus the nodes in the resulted global distributed hash table are typically located at the bottom of that global distributed hash table.

It should be understood that the method described above for determining a node identifier is merely an example and is not intended to limit the scope of the present disclosure. Any suitable method may be used to determine the node identifier, such as using other hash algorithms to determine the hash value of the node.

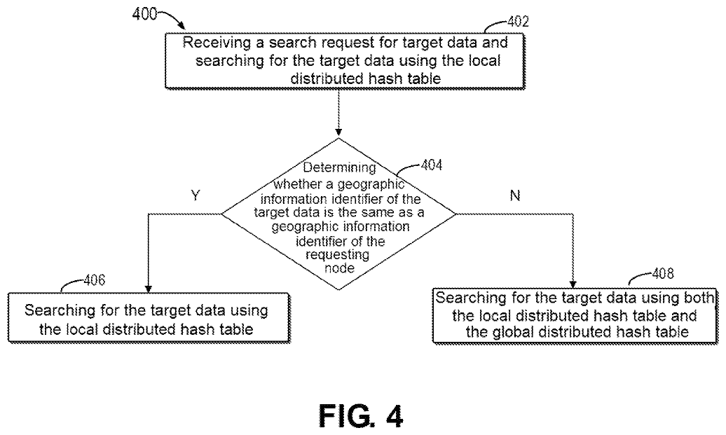

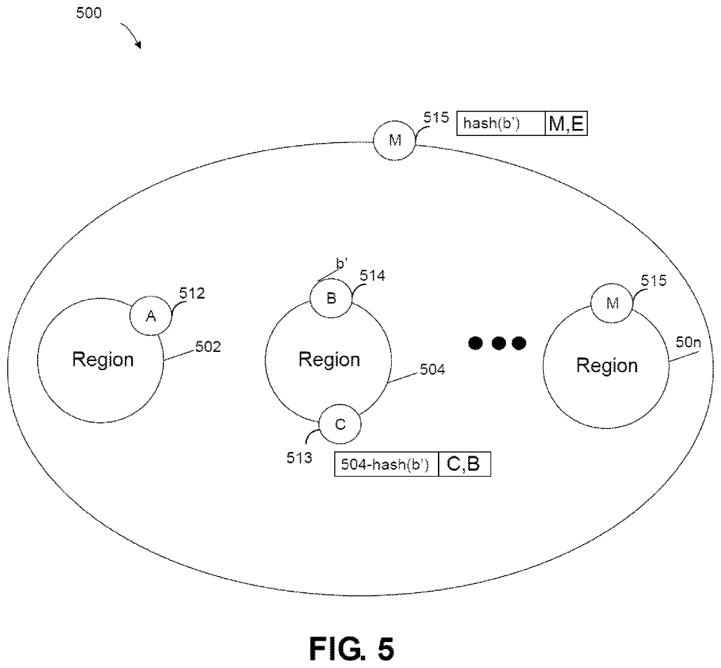

Another example in which search is performed using both a local distributed hash table and a global distributed hash table according to an embodiment of the present disclosure will be discussed below by combining FIG. 4 and FIG. 5. Among them, FIG. 4 illustrates flow chart 400 of an embodiment in which searching is performed using both a local distributed hash table and a global distributed hash table, and FIG. 5 illustrates a schematic diagram 500 of such an embodiment, which illustratively includes node A 512, node B 514, node C 513, . . . node M 515, and region 502, region 504, . . . region 50n.

In method 400 as shown in FIG. 4, at block 402, the requesting node first receives a search request for target data and determines whether a data identifier of the target data is a local data identifier or a global data identifier, and if the data identifier of the target data is the local data identifier, the requesting node searches for the target data using the local distributed hash table. For example, node A 512 in FIG. 5 receives a search request for target data b′ stored at node B 514 and determines to search for target data b′ using the local distributed hash table for node A 512 in response to determining that the data identifier of target data b′ has the local data identifier.

At block 404, the requesting node may then determine whether a geographic information identifier of the target data is the same as a geographic information identifier of the requesting node. For example, when node A 512 attempts to search for the target data b′, node C 513 may first determine whether the geographic information identifier of the target data is the same as the geographic information identifier of the requesting node.

At block 406, if it can be determined that the geographic information identifier of the target data is the same as the geographic information identifier of the requesting node, the requesting node searches for the target data using the local distributed hash table. In this example, if the geographic information identifier of the local data identifier of the target data b′ has the same geographic information identifier “512-” as node A 512, node A 512 can continue to search for the target data using the local distributed hash table.

At block 408, if the geographic information identifier of the target data is different from the geographic information identifier of the requesting node, the requesting node can search for the target data using both the local distributed hash table and the global distributed hash table. For example, in FIG. 5, if node A 512 determines that the geographic information identifier of the target data b′ is different from the geographic information identifier of node A 512 itself, i.e., in this example, the geographic information identifier of the target data b′ is “504-” while the geographic information identifier of node A 512 is “502-,” then node A 512 can search for the target data b′ using both the local distributed hash table and the global distributed hash table. Node A 512 may find that node C 513 in region 504 has a local data identifier 504-hash(b) associated with the target data b′ by searching the local distributed hash table, and find the node B 514 storing the target data b′ based on routing information that is associated with the data identifier 504-hash(b′) at node C 513. Meanwhile, node A 512 may find that node M 515 in distributed system 500 has a global data identifier hash(b′) associated with the target data b′ by searching the global distributed hash table, and find node B 514 storing the target data b′ based on routing information that is associated with the data identifier hash(b′) at node M 515. Once node A 512 finds the target data b′ by searching one of the local distributed hash table or the global distributed hash table, node A 512 stops searching the other distributed hash table.

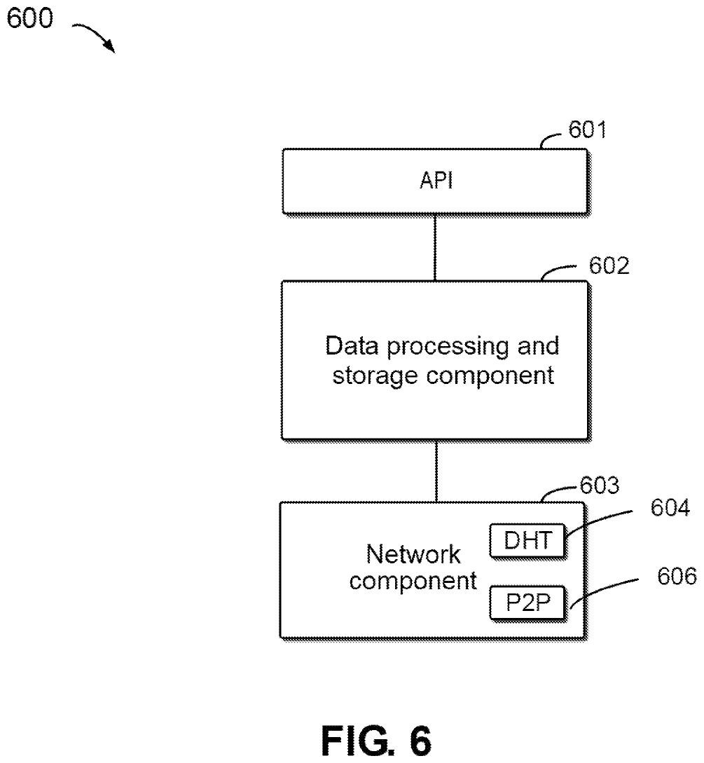

FIG. 6 illustrates a schematic diagram 600 of management of geographic information identifiers within a node. Inside a node, application programming interface (API) component 601, data processing and storage component 602, and network component 603 may be included, wherein network component 603 may further include DHT component 604 and P2P component 606, where P2P denotes “peer-to-peer.” According to some embodiments of the present disclosure, the geographic information identifier may be used only when the node is performing information processing with other nodes in the distributed system, such as when the API component of the node needs to program the node to record node information in a local distributed hash table, or when the geographic information identifier may be needed by API component 601 and DHT component in network component 603 in the node when comparing the distance of the requesting node with that of the requesting node in the distributed hash table, the geographic information identifier may be added to the data identifier of the node, thus enabling a quick comparison of the distance with other nodes. In another embodiment, when a node transmits data with another node via P2P transmission, P2P component 606 of the node may need to use the geographic information identifier; while when information processing is performed within the node, it may not be necessary to use the geographic information identifier, and thus the geographic information identifier may be removed when the data identifier is used in data processing and storage component 602 within the node. By applying this mechanism, the present disclosure provides a flexible routing policy for network component 603 including a distributed hash table, while maintaining consistency and independence in the use of data in the internal data processing and storage component 602 and saving storage space within the node.

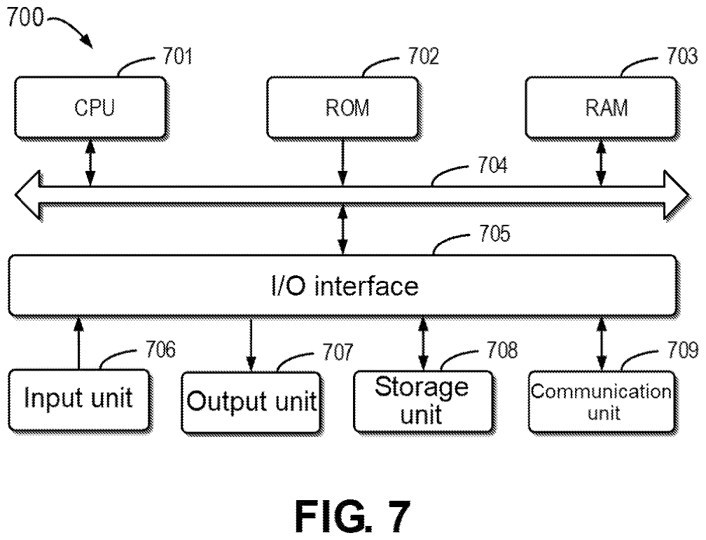

FIG. 7 shows a schematic block diagram of example device 700 that can be used to implement embodiments of the present disclosure. The nodes in FIG. 1 may be implemented using device 700. As shown in the figure, device 700 includes central processing unit (CPU) 701 that may perform various appropriate actions and processing according to computer program instructions stored in read-only memory (ROM) 702 or computer program instructions loaded from storage unit 708 to random access memory (RAM) 703. Various programs and data required for the operation of device 700 may also be stored in RAM 703. CPU 701, ROM 702, and RAM 703 are connected to each other through bus 704. Input/Output (I/O) interface 705 is also connected to bus 704.

A plurality of components in device 700 are connected to I/O interface 705, including: input unit 706, such as a keyboard and a mouse; output unit 707, such as various types of displays and speakers; storage unit 708, such as a magnetic disk and an optical disc; and communication unit 709, such as a network card, a modem, and a wireless communication transceiver. Communication unit 709 allows device 700 to exchange information/data with other devices via a computer network, such as the Internet, and/or various telecommunication networks.

The various methods and processes described above, such as methods 200 and 400, may be performed by CPU 701. For example, in some embodiments, methods 200 and 400 may be implemented as a computer software program that is tangibly included in a machine-readable medium such as storage unit 708. In some embodiments, part or all of the computer program may be loaded and/or installed onto device 700 via ROM 702 and/or communication unit 709. When the computer program is loaded into RAM 703 and executed by CPU 701, one or more steps of methods 200 and 400 described above can be implemented.

Embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented by using a special hardware-based system that executes specified functions or actions, or implemented by using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments or technical improvements to technologies on the market, so as to enable persons of ordinary skill in the art to understand the embodiments disclosed herein.

What is claimed is:

1. A method for searching for data, the method comprising:
determining, in response to receiving at a requesting node a search request for target data, a data identifier of the target data;
determining whether the data identifier of the target data is a local data identifier or a global data identifier;
searching for the target data using a local distributed hash table in response to determining that the data identifier is the local data identifier; and
searching for the target data using a global distributed hash table in response to determining that the data identifier is the global data identifier.

2. The method according to claim 1, wherein searching for the target data using a local distributed hash table comprises:
determining whether a geographic information identifier of the local data identifier of the target data is the same as a geographic information identifier of the requesting node;
searching for the target data using the local distributed hash table in response to the geographic information identifier of the local data identifier of the target data being the same as the geographic information identifier of the requesting node; and
searching for the target data using both the local distributed hash table and the global distributed hash table in response to the geographic information identifier of the local data identifier of the target data being different from the geographic information identifier of the requesting node.

3. The method according to claim 2, wherein searching for the target data using the local distributed hash table comprises:
sending a search request for the target data to a plurality of nodes that are within a first distance range based on the local distributed hash table; and
sending, in response to the target data being not found from the plurality of nodes that are within the first distance range, a search request for the target data to a plurality of nodes that are within a second distance range, wherein distances in the second distance range are greater than distances in the first distance range.

4. The method according to claim 2, wherein searching for the target data using both the local distributed hash table and the global distributed hash table comprises:
stopping, in response to the target data being found using the local distributed hash table, searching for the target data using the global distributed hash table; and
stopping, in response to the target data being found using the global distributed hash table, searching for the target data using the local distributed hash table.

5. The method according to claim 1, wherein the local data identifier comprises a geographic information identifier and a hash identifier of the target data, and wherein the global data identifier comprises a hash identifier of the target data.

6. The method according to claim 1, wherein the requesting node is located in a first region, and wherein the method further comprises:
generating a first part of the local distributed hash table based on distances between the requesting node and other nodes within the first region;
generating a second part of the local distributed hash table based on distances between the requesting node and nodes within a second region; and
generating the local distributed hash table based at least on the first part and the second part.

7. The method according to claim 6, further comprising:
generating the global distributed hash table based on distances between the requesting node and all nodes within a distributed system.

8. The method according to claim 1, further comprising:
storing, in response to receiving a data storage request at a first node, data at the first node;
storing, based on the local distributed hash table, metadata for the data at a second node that is located in the same region as the first node; and
storing, based on the global distributed hash table, the metadata for the data at a third node.

9. An electronic device, comprising:
at least one processor; and
a memory coupled to the at least one processor and having instructions stored therein, wherein the instructions, when executed by the at least one processor, cause the electronic device to perform actions comprising:
determining, in response to receiving at a requesting node a search request for target data, a data identifier of the target data;
determining whether the data identifier of the target data is a local data identifier or a global data identifier;
searching for the target data using a local distributed hash table in response to determining that the data identifier is the local data identifier; and
searching for the target data using a global distributed hash table in response to determining that the data identifier is the global data identifier.

10. The electronic device according to claim 9, wherein searching for the target data using a local distributed hash table comprises:
determining whether a geographic information identifier of the local data identifier of the target data is the same as a geographic information identifier of the requesting node;
searching for the target data using the local distributed hash table in response to the geographic information identifier of the local data identifier of the target data being the same as the geographic information identifier of the requesting node; and
searching for the target data using both the local distributed hash table and the global distributed hash table in response to the geographic information identifier of the local data identifier of the target data being different from the geographic information identifier of the requesting node.

11. The electronic device according to claim 10, wherein searching for the target data using the local distributed hash table comprises:
sending a search request for the target data to a plurality of nodes that are within a first distance range based on the local distributed hash table; and
sending, in response to the target data being not found from the plurality of nodes that are within the first distance range, a search request for the target data to a plurality of nodes that are within a second distance range, wherein distances in the second distance range are greater than distances in the first distance range.

12. The electronic device according to claim 10, wherein searching for the target data using both the local distributed hash table and the global distributed hash table comprises:
stopping, in response to the target data being found using the local distributed hash table, searching for the target data using the global distributed hash table; and
stopping, in response to the target data being found using the global distributed hash table, searching for the target data using the local distributed hash table.

13. The electronic device according to claim 9, wherein the local data identifier comprises a geographic information identifier and a hash identifier of the target data, and wherein the global data identifier comprises a hash identifier of the target data.

14. The electronic device according to claim 9, wherein the requesting node is located in a first region, and the actions further comprise:
generating a first part of the local distributed hash table based on distances between the requesting node and other nodes within the first region;
generating a second part of the local distributed hash table based on distances between the requesting node and nodes within a second region; and
generating the local distributed hash table based at least on the first part and the second part.

15. The electronic device according to claim 14, the actions further comprising:
generating the global distributed hash table based on distances between the requesting node and all nodes within a distributed system.

16. The electronic device according to claim 9, the actions further comprising:
storing, in response to receiving a data storage request at a first node, data at the first node;
storing, based on the local distributed hash table, metadata for the data at a second node that is located in the same region as the first node; and
storing, based on the global distributed hash table, the metadata for the data at a third node.

17. A computer program product that is tangibly stored on a non-transitory computer-readable medium and comprises machine-executable instructions, wherein the machine-executable instructions, when executed by a machine, cause the machine to perform a method for searching for data, the method comprising:
determining, in response to receiving at a requesting node a search request for target data, a data identifier of the target data;
determining whether the data identifier of the target data is a local data identifier or a global data identifier;
searching for the target data using a local distributed hash table in response to determining that the data identifier is the local data identifier; and
searching for the target data using a global distributed hash table in response to determining that the data identifier is the global data identifier.

18. The computer program product according to claim 17, wherein searching for the target data using a local distributed hash table comprises:
determining whether a geographic information identifier of the local data identifier of the target data is the same as a geographic information identifier of the requesting node;
searching for the target data using the local distributed hash table in response to the geographic information identifier of the local data identifier of the target data being the same as the geographic information identifier of the requesting node; and
searching for the target data using both the local distributed hash table and the global distributed hash table in response to the geographic information identifier of the local data identifier of the target data being different from the geographic information identifier of the requesting node.

19. The computer program product according to claim 18, wherein searching for the target data using the local distributed hash table comprises:
sending a search request for the target data to a plurality of nodes that are within a first distance range based on the local distributed hash table; and
sending, in response to the target data being not found from the plurality of nodes that are within the first distance range, a search request for the target data to a plurality of nodes that are within a second distance range, wherein distances in the second distance range are greater than distances in the first distance range.

20. The computer program product according to claim 18, wherein searching for the target data using both the local distributed hash table and the global distributed hash table comprises:
stopping, in response to the target data being found using the local distributed hash table, searching for the target data using the global distributed hash table; and
stopping, in response to the target data being found using the global distributed hash table, searching for the target data using the local distributed hash table.
